(19) United States
(12) Patent Application Publication
(10) Pub. No.: US 2025/0340144 A1
(43) Pub. Date: Nov. 6, 2025

(54) MODULAR INTERFACE PLATE FOR CHARGE INLET COOLING

(71) Applicant: Dana Heavy Vehicle Systems Group, LLC, Maumee, OH (US)

(72) Inventors: Guillaume DESOURDY, Terrebonne (CA); Thomas PICHEMEUNIER, Montreal (CA); Abbas AGHAGOLI, Boisbriand (CA); Louis-Andre CALVE, Terrebonne (CA)

(21) Appl. No.: 18/655,100

(22) Filed: May 3, 2024

(51) Int. Cl. B60L 53/302; B60L 53/16

(52) U.S. Cl. CPC B60L 53/302; B60L 53/16

(57) ABSTRACT

Systems for cooling a charge inlet of an electric vehicle are provided. In one example, interface plate for cooling a charge inlet of an electric vehicle may include a front face configured to be positioned in face-sharing contact with the charge inlet, a back face opposite the front face, a charge inlet aperture, an inlet recess surrounding the charge inlet aperture and including a recessed surface that is recessed relative to the front face, wherein the charge inlet aperture is defined by an inner surface comprised of a plurality of aperture segments that extend from the recessed surface to the back face, and a cooling channel integrated within the interface plate.

### TECHNICAL FIELD

Embodiments of the subject matter disclosed herein relate to electric vehicles and, more particularly, to cooling a charge inlet of an electric vehicle.

### BACKGROUND/SUMMARY

Certain types of electric vehicle charging systems, such as megawatt charging systems (MCS), include a charge coupler configured to mate with a charge inlet of an electric vehicle and charge one or more batteries of the electric vehicle in short timespans by providing relatively large amounts of current to the one or more batteries. However, the large amounts of current may result in heat generation at the charge inlet.

Other attempts to address the generation of heat at the charge inlet include coupling the charge inlet to the vehicle cooling system and/or inclusion of specific cooling elements within the charge inlet. For example, German Patent Application No. DE102020132724A1 to Babezki et al. discloses a liquid-cooled charge inlet that includes one or more cooling modules configured to dissipate heat from load contacts within the charge inlet.

However, the inventors herein have recognized an issue with the approach set forth in Babezki. Including cooling modules within the charge inlet may increase the manufacturing complexity of the charge inlet. Similarly, liquid cooling the charge inlet may increase the manufacturing complexity of the charge inlet. Further, the cooling modules disclosed in Babezki may only cool the load contacts of the charge inlet and do not address cooling demands at other areas of the charge inlet, and are limited to the particular design of the charge inlet set forth in Babezki. As such, the approach of Babezki may not be implementable in other charge inlet configurations. Furthermore, some vehicle manufacturers may install charge inlets manufactured by third-party manufacturers, which may not include sufficient cooling capacity. Relying only on cooling of the charge inlet via features within the charge inlet may limit the available configurations of the charge inlet that can be installed.

Accordingly, in one example, the above issues may be addressed with an interface plate for cooling a charge inlet of an electric vehicle. The interface plate may include a front face configured to be positioned in face-sharing contact with the charge inlet, a back face opposite the front face, a charge inlet aperture, an inlet recess surrounding the charge inlet aperture and including a recessed surface that is recessed relative to the front face, wherein the charge inlet aperture is defined by an inner surface comprised of a plurality of aperture segments that extend from the recessed surface to the back face, and a cooling channel integrated within the interface plate. In this way, the interface plate may be modular in design so that the interface plate can be installed in coordination with a plurality of charge inlet products but is not integrated directly into a charge inlet, thereby ensuring sufficient cooling of the charge inlet regardless of charge inlet design and simplifying manufacture of the charge inlet, thereby lowering the cost of the charge inlet.

The above advantages and other advantages and features of the present description will be readily apparent from the following Detailed Description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram of an electric vehicle charging system.

FIG. 2A is a front view of an interface plate configured to cool a charge inlet within an electric vehicle.

FIG. 2B is a front view of the interface plate of FIG. 2A showing internal cooling channels.

FIG. 3 is a side view of the interface plate of FIG. 2A.

FIG. 4A is a side view of the interface plate of FIG. 2A with fastening apertures shown within the interface plate.

FIG. 4B is a side view of the interface plate of FIG. 2A with the cooling channels shown within the interface plate.

FIG. 5A is a back view of the interface plate of FIG. 2A.

FIG. 5B is back view of the interface plate of FIG. 2A including cooling channels and fastening apertures within the interface plate.

FIG. 6 is a cross sectional view of the interface plate of FIG. 2A.

FIG. 7 is a front view of the interface plate of FIG. 2A coupled to a megawatt charge system (MCS) charge inlet.

FIG. 8 is a back view of the interface plate of FIG. 2A coupled to the MCS charge inlet.

FIG. 9 is a back view of the interface plate of FIG. 2A coupled to the MCS charge inlet and a pair of busbars.

FIG. 10 is a side view of the interface plate of FIG. 2A coupled to the MCS charge inlet.

FIG. 11 is a side view of the interface plate of FIG. 2A coupled to the MCS charge inlet and the pair of busbars.

FIG. 12 is perspective view of the interface plate of FIG. 2A coupled to the MCS charge inlet and the pair of busbars.

FIG. 13 is a side view of the MCS charge inlet.

### DETAILED DESCRIPTION

This description and embodiments of the subject matter disclosed herein relate to a modular interface plate with busbars that can be installed between a charge inlet and power distribution hardware of an electric vehicle. The charge inlet is an electrical component configured to receive current from a charger (e.g., a charge coupler of a charging station) outside of the vehicle and transfer that current to the power distribution hardware. The charge inlet is further configured to monitor the charging process. For example, the charge inlet may detect the amount of current through the charge inlet, receive feedback on the amount of charge stored in a battery of the vehicle, and may stop the flow of current through the charge inlet responsive to feedback on the amount of charge stored in the battery. The power distribution hardware is configured to distribute the power received via the charge inlet to a plurality of systems, such as sensors used to monitor a charging process and into the vehicle battery. The power distribution hardware may be configured to handle high currents during charging.

In some examples, the charge inlet may be a megawatt charge inlet configured to accept a megawatt charge coupler. Megawatt charging can deliver megawatts of current to the electric vehicle through the charge inlet. The heat generated by an electrical component due to electrical resistance increases with the amount of current that is passed through the electrical component. The large amount of current that passes through a megawatt charge inlet in a megawatt system can generate large amounts of heat. Cooling the megawatt charge inlet may extend its useable lifetime.

According to the embodiments herein, the charge inlet may be cooled by an interface plate installed between the charge inlet and the power distribution hardware. The interface plate may include cooling channels integrated within the interface plate, and busbars separated from the interface plate by a thermal interface material. The interface plate may include an aperture through which components of the charge inlet, such as pins, can extend. The pins may deliver current from the charge inlet to electrical components within the vehicle. The busbars coupled to the interface plate may include a pair of busbars coupled to the interface plate such that a respective aperture on each busbar aligns with a respective pin that extends from the charge inlet. The busbars may be electrically and thermally conductive and may electrically couple the pins to power distribution hardware and may thermally couple the pins to the interface plate. The busbars may be electrically insulated from the interface plate by a layer of thermal interface material, which allows the busbars and the interface plate to be electrically isolated but thermally coupled.

As mentioned above, one or more cooling channels may be integrated within the interface plate. In some examples, the cooling channels may be coupled to a cooling system within the vehicle, and may be configured to conduct cooling fluid through the interface plate. The cooling system within the vehicle may be configured to pump cooling fluid through the channels and may include a heat exchanger to release heat from the cooling fluid. The interface plate may conduct heat from the charge inlet and the busbars. The heat within the interface plate may then be conducted by the cooling fluid within the channels and circulated out of the channels by a cooling system within the vehicle. In other examples, the one or more cooling channels may accommodate a heat pipe.

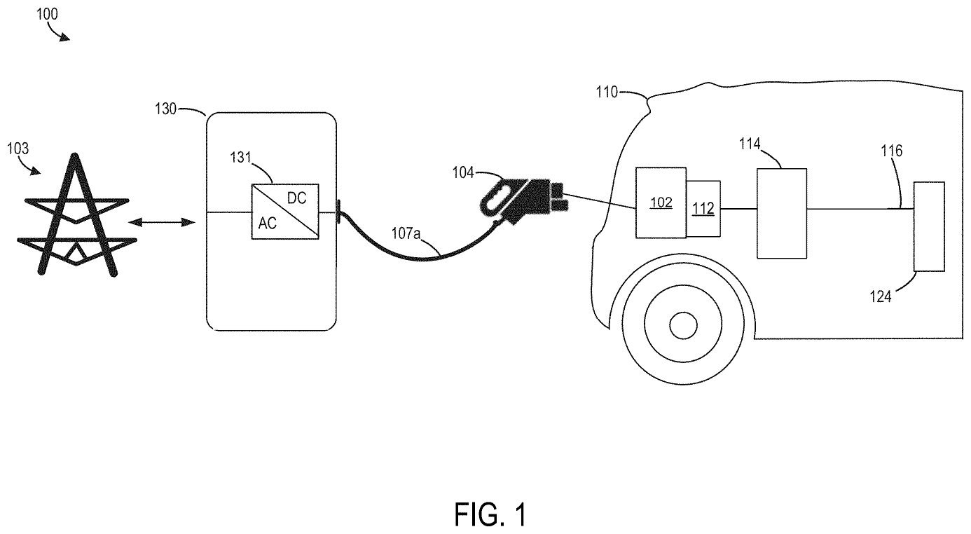

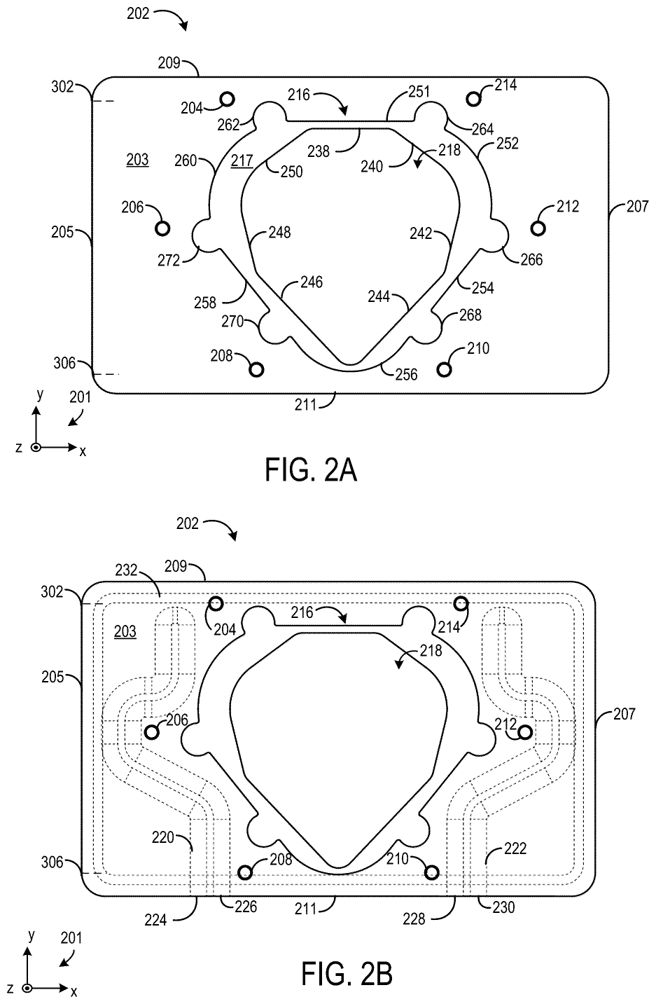

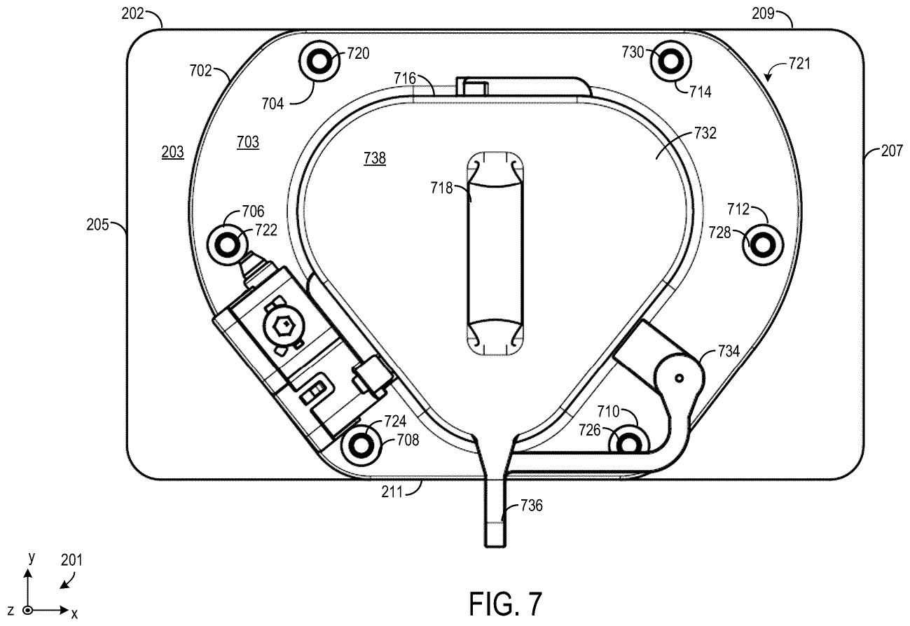

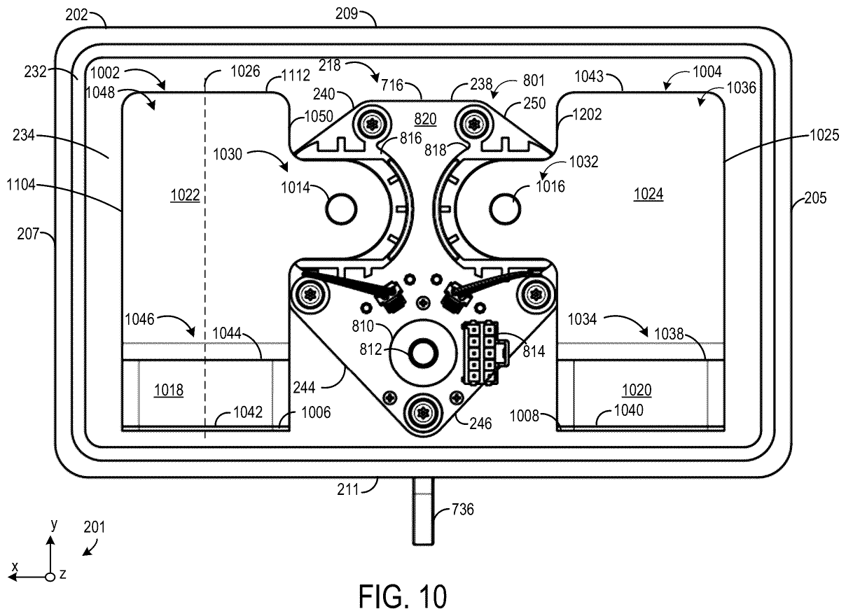

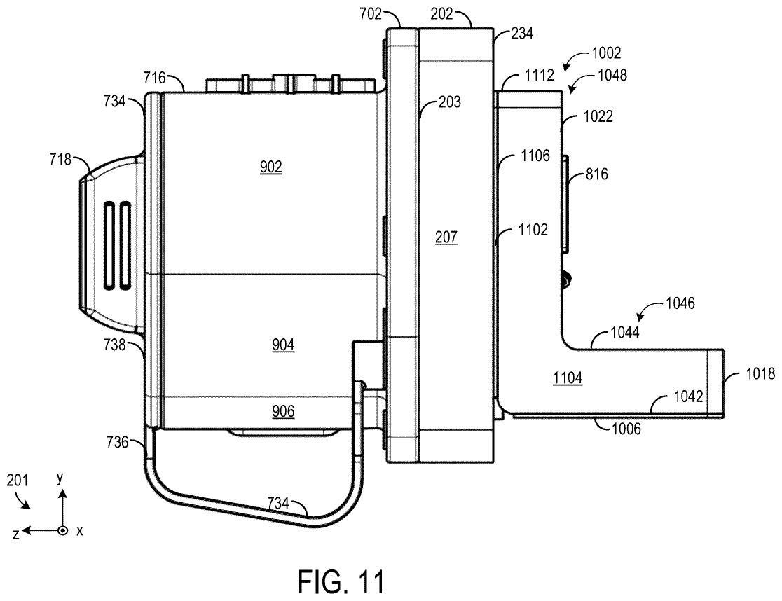

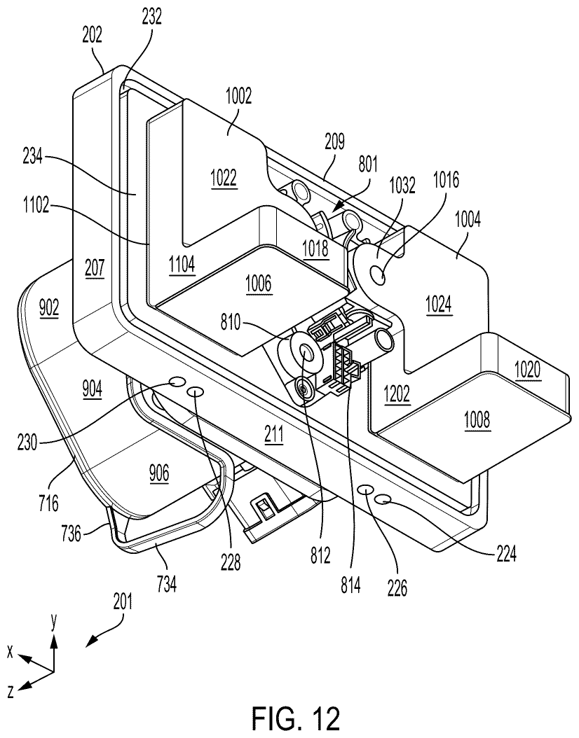

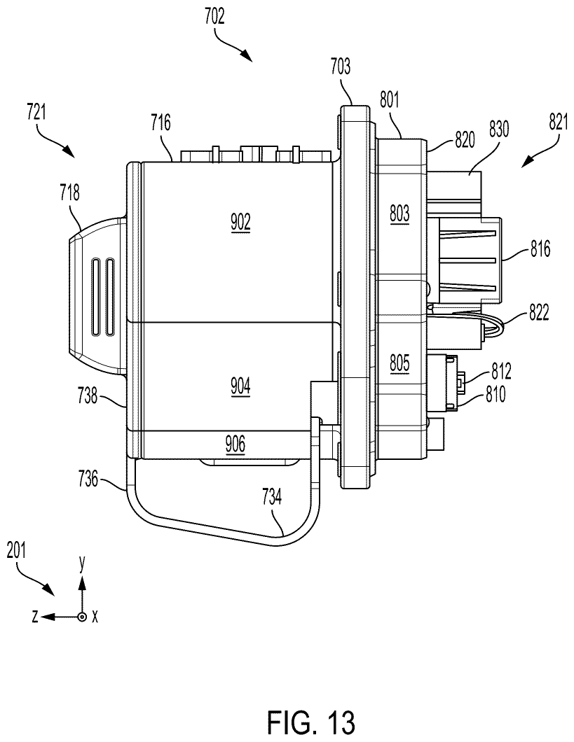

The interface plate disclosed herein may be coupled to a charge inlet of a charging system, such as a megawatt charging system (MCS), of an electric vehicle, as shown schematically in FIG. 1. The MCS may include a charge inlet configured to receive a MCS charge coupler and supply power from the MCS charge coupler to a power distribution unit (PDU) of the electric vehicle. The interface plate may include an aperture that accommodates aspects of the charge inlet and a pair of busbars coupled to the interface plate may electrically couple the charge inlet to the PDU or to cables that are coupled to the PDU. FIGS. 2-6 illustrate a plurality of views of the interface plate showing external and internal components of the interface plate. FIGS. 7, 8, and 9 are front, back, and side views, respectively, of the interface plate coupled to the charge inlet. FIGS. 10-12 show the interface plate coupled to the charge inlet with a pair of busbars that are coupled to the interface plate and the charge inlet. FIG. 13 is a side view of an MCS charge inlet isolated from the interface plate and busbars.

FIG. 1 schematically illustrates a charging configuration 100 for charging a vehicle with a charge inlet. The charging configuration 100 is shown in a simplified form in FIG. 1. The charging configuration 100 may include an energy grid 103 that provides power to the charging configuration 100. The energy grid 103 may derive power from a variety of sources, which may include nuclear power plants, solar panel arrays, wind turbine arrays or other sources. An electric vehicle (EV) charging station 130 may include an AC to DC converter 131 to convert energy from electric vehicle 110 to energy grid 103 or from energy grid 103 to electric vehicle 110 to charge electric vehicle 110. The EV charging station 130 may be electrically coupled to a battery 124 through a DC output 116 and a PDU 114. The DC output 116 may be an electric vehicle 110. The electric vehicle 110 may be a fully electric vehicle or a hybrid electric vehicle. The electric vehicle 110 may be a car, van, truck, or other vehicle that may be propelled by a motor that may be coupled to a battery 124.

The PDU 114 may direct the flow of charge to and from the battery 124 and may be adapted to protect the battery 124 from current surges during charging. The PDU 114 may include fuses to protect the battery 124, as well as contactors that control the flow of current. Contactors may be capable of opening and closing to interrupt or complete the charging circuit. The contactors may be closed when charging begins and may be opened when the charging is completed or interrupted.

EV charging station 130 electrically couples energy from energy grid 103 to electric vehicle 110 through a first wire 107a and charge coupler 104. The charge coupler 104 may be electrically coupled to the DC output 116 via a vehicle charge inlet 102. The vehicle charge inlet 102 may be adapted to electrically couple to the charge coupler 104. In some examples, the charge coupler 104 may be a charge coupler of a high voltage megawatt charging system (MCS). In such examples, the charge coupler 104 may be referred to as a MCS coupler.

In the example that the charge coupler 104 is a MCS coupler, the vehicle charge inlet 102 may be adapted to accommodate and couple to the MCS coupler. Significant contact resistance may occur at the point of contact between the vehicle charge inlet 102 and the DC output 116, which may cause resistive heating. A cooling apparatus 112 may be installed in contact with the charge inlet 102. The cooling apparatus 112 may include an interface plate and a pair of busbars. The interface plate may cool the charge inlet 102 and the busbars may electrically couple the charge inlet 102 to the PDU 114 via the DC output 116.

FIGS. 2A, 2B, 3, 4A, 4B, 5A, 5B, and 6 are a plurality of views of an interface plate 202 that may be included within the cooling apparatus 112. FIGS. 2A-12 include a Cartesian coordinate system 201 to orient the views. The coordinate system may be arranged with respect to the position of parts once they are assembled into the charge inlet of an electric vehicle. The y-axis of coordinate system 201 may be a vertical axis (e.g., parallel to a gravitational axis), the x-axis of coordinate system 201 may be a longitudinal axis (e.g., horizontal axis), and/or the z-axis of coordinate system 201 may be a lateral axis, in one example. However, the axes may have other orientations, in other examples. When referencing direction, positive may refer to in the direction of the arrow of the x-axis, y-axis, and z-axis and negative may refer to in the opposite direction of the arrow of the x-axis, y-axis, and z-axis. A filled circle may represent an arrow and axis facing toward, or positive to, a view. An unfilled circle may represent an arrow and an axis facing away, or negative to, a view. Further, FIGS. 2A-13 are drawn to scale, though other relative dimensions could be used if desired.

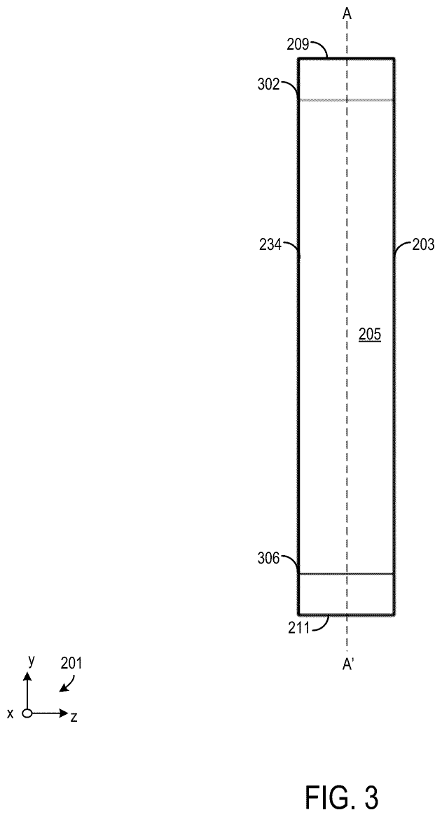

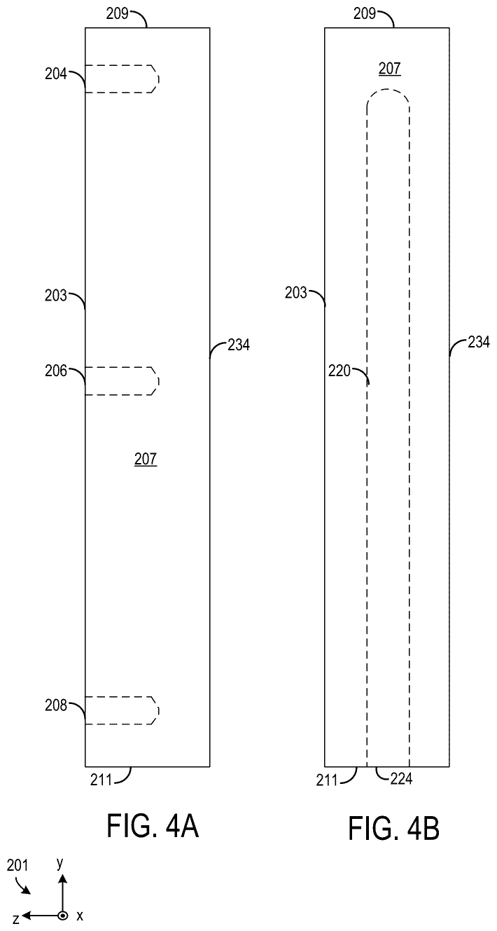

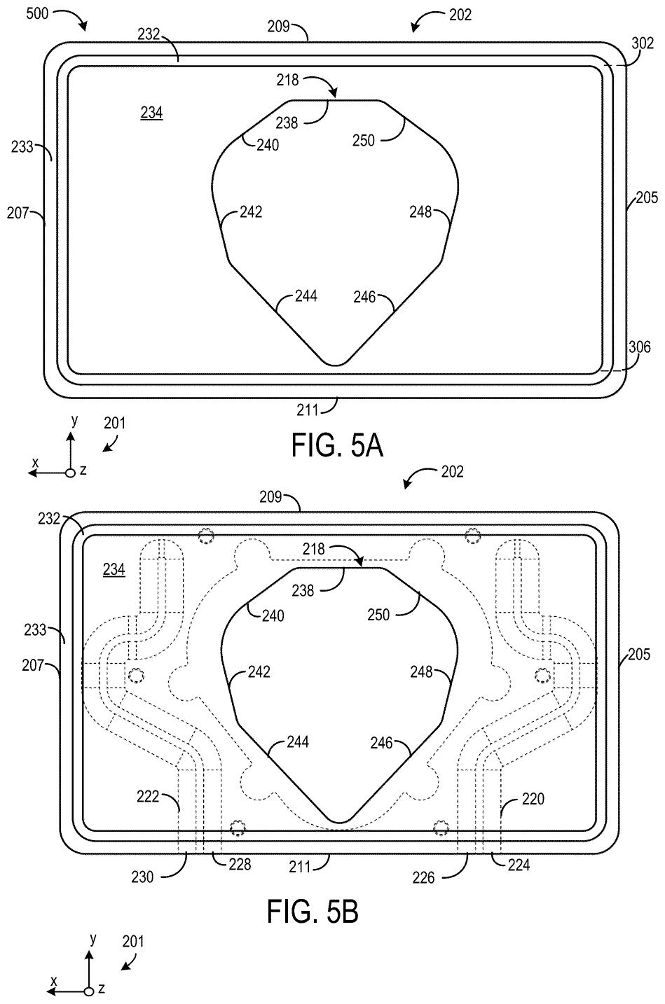

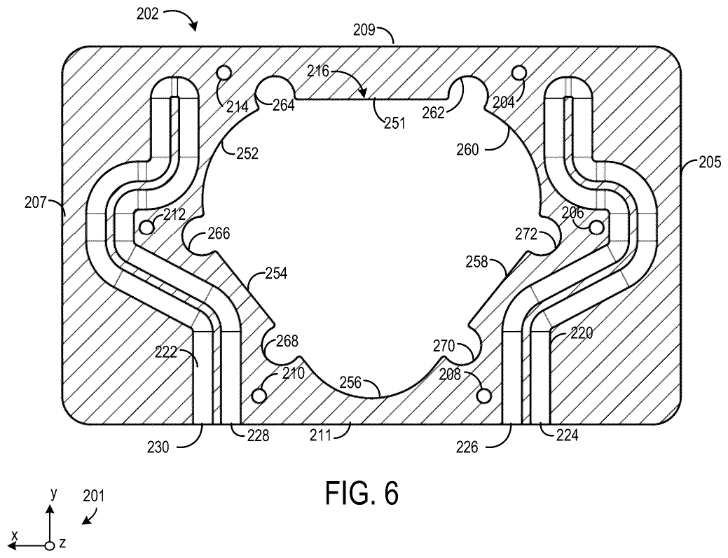

FIGS. 2A and 2B are front views of the interface plate 202 showing a front face 203 of the interface plate 202, with components within the interface plate 202 shown as dashed lines in FIG. 2B. FIGS. 3, 4A, and 4B are side views of the interface plate 202, wherein FIG. 3 is the view from the outside of the interface plate 202, and FIGS. 4A and 4B each show a subset of internal components within the interface plate 202 represented by dashed lines. FIG. 5A is a back view of the interface plate 202 from the outside and FIG. 5B is a view of the back of the interface plate 202 with internal components of the interface plate 202 (as well as features of the interface plate on the front of the interface plate) shown by dashed lines. FIG. 6 is a cross-sectional view of the interface plate 202 across a line A-A′ shown in FIG. 3 that passes through the center of the interface plate 202 in the x-y plane. FIGS. 2A-6 are described collectively.

The interface plate 202 may be rectangular in shape with rounded corners. The front face 203 of the interface plate 202 may be planar in shape and may be configured to make face sharing contact with a charge inlet, such as a MCS charge inlet, when the charge inlet is coupled to the interface plate 202. The interface plate 202 may include a first side 205, a second side 207 opposite the first side 205, a top 209, and a bottom 211. The front face 203 may extend from the first side 205 to the second side 207 and from the top 209 to the bottom 211. Each corner represents a position at which a respective edge of the interface plate 202 transitions from a straight side to a rounded corner. The first side 205 transitions to the top 209 at a first corner 302 and to the bottom at a second corner 306, marked by dashed lines. The first corner 302 and the second corner 306 are shown in the side profile of the interface plate 202 shown in FIG. 3 by lines that mark the line of transition from the straight portion of the first side 205 to the first corner 302 and the second corner 306. Similarly, the second side 207 transitions to the top 209 and to the bottom 211 via a third corner and a fourth corner, respectively. The interface plate 202 may be comprised of a thermally conductive material such as aluminum, copper, or steel. The interface plate 202 may be configured to couple to the charge inlet, and thus includes a charge inlet aperture 218 that is formed to accommodate a portion of the charge inlet and allow the portion of the charge inlet to extend through the interface plate 202.

The charge inlet aperture 218 may be defined by an inner surface made of a plurality of segments that extend through the depth of the interface plate 202 (e.g., parallel to the z axis). A first aperture segment 238 may be a straight segment located near the top of the interface plate 202 that extends horizontally (e.g., parallel to the x-axis). The first aperture segment 238 may be coupled to a second aperture segment 240 at an obtuse angle and may create a corner. The second aperture segment 240 may be a straight segment. The second aperture segment 240 may be coupled to a third aperture segment 242 at an obtuse angle and the second aperture segment 240 may be joined to the third aperture segment 242 by a rounded corner. The third aperture segment 242 may be a straight segment. The third aperture segment 242 may be joined to the fourth aperture segment 244 at an obtuse angle and may create a corner. The fourth aperture segment 244 may be a straight segment. The fourth aperture segment 244 may be joined to a fifth aperture segment 246 at a rounded corner positioned near the bottom of the interface plate 202, and the fourth aperture segment 244 and the fifth aperture segment 246 may form an acute angle. The fifth aperture segment 246 may be a straight segment that is joined to a sixth aperture segment 248 at an obtuse angle, and may form a corner. The sixth aperture segment 248 may be a straight segment that is joined to a seventh aperture segment 250 at a rounded corner and the sixth aperture segment 248 may form an obtuse angle with the seventh aperture segment 250. In this way, the charge inlet aperture 218 may have an irregular heptagon shape and may be symmetric along an axis of symmetry that extends parallel to the y-axis.

The charge inlet aperture 218 may be surrounded by an inlet recess 216 set into the front face 203 of the interface plate 202. The inlet recess 216 may be set a particular depth into the front face 203 of the interface plate 202. For example, the inlet recess 216 may be set into the front face 203 at a depth in a range of 20-25 mm, such as 22 mm. In some examples, the interface plate 202 may have an overall depth of 25-40 mm, such that the inlet recess 216 may set into the front face 203 at a depth that is more than half the overall depth of the interface plate 202 (e.g., 75% or more of the overall depth). The depth of the inlet recess 216 may be such that it matches the contours of the charge inlet and allows the charge inlet to sit substantially flush against the interface plate 202 (e.g., flush or separated by a relatively small amount, such as less than 1 mm). The inlet recess 216 may provide clearance for the body of the charge inlet, as explained in more detail below. The interface plate 202 may be shaped to clear the body of the change inlet and not to impede the intended installation method of the charge inlet while also remaining as thin as possible while providing a thermal interface to the busbar on the backside of the charge inlet.

The inlet recess 216 may be shaped to include a plurality of semicircular notches that may reflect the shape of the charge inlet. The inlet recess 216 may be defined on one side by an outer recess edge made up of a first recess segment 251, a second recess segment 252, a third recess segment 254, a fourth recess segment 256, a fifth recess segment 258, and a sixth recess segment 260 as well as a first semicircular notch 262, a second semicircular notch 264, a third semicircular notch 266, a fourth semicircular notch 268, a fifth semicircular notch 270, and a sixth semicircular notch 272. The outer recess edge may be where the front face 203 intersects with a side surface of the inlet recess 216 that extends along the z axis (from the front face 203 toward the back of the interface plate 202). The side surface of the inlet recess 216 may intersect a recessed surface 217 that surrounds the charge inlet aperture 218. The recessed surface 217 may be a region of a front surface of the interface plate 202 that is recessed relative to the front face 203. In this way, the interface plate 202 may include a front surface that is comprised of the front face 203 and the recessed surface 217. The inlet recess 216 may be defined on an inner side by the charge inlet aperture 218. The recessed surface 217 between the outer recess edge and the charge inlet aperture 218 may be on an x-y plane at a more negative position along the z-axis than the front face 203. The plurality of segments that define the charge inlet aperture 218 may extend from the back face 234 of the interface plate to the recessed surface 217.

The first recess segment 251 is a horizontal segment located near the top of the interface plate 202. The first recess segment 251 is coupled to the second semicircular notch 264, which is a semicircular portion of the inlet recess 216 that extends outward from the first recess segment 251 and a second recess segment 252. The second recess segment 252 may be curved to mimic a rounded version of the corner formed by the second aperture segment 240 and the third aperture segment 242. The second recess segment 252 is coupled to the third semicircular notch 266. The third semicircular notch 266 is coupled to a third recess segment 254. The third recess segment 254 is straight and coupled to the fourth semicircular notch 268. The fourth semicircular notch 268 is coupled to a fourth recess segment 256. The fourth recess segment 256 is curved in shape to mimic the corner formed by the fourth aperture segment 244 and the fifth aperture segment 246. The fourth recess segment 256 is coupled to the fifth semicircular notch 270. The fifth semicircular notch 270 is coupled to a fifth recess segment 258. The fifth recess segment 258 is straight and coupled to the sixth semicircular notch 272. The sixth semicircular notch 272 is coupled to a sixth recess segment 260. The sixth recess segment 260 is a curved segment that mimics the shape of the sixth aperture segment 248 and the seventh aperture segment 250. The sixth recess segment 260 is coupled to the first semicircular notch 262, which is in turn coupled to the first recess segment 251.

The interface plate 202 may include a plurality of fastening apertures distributed on the front face 203 of the interface plate 202. The fastening apertures may include a first fastening aperture 204, a second fastening aperture 206, a third fastening aperture 208, a fourth fastening aperture 210, a fifth fastening aperture 212, and a sixth fastening aperture 214. The fastening apertures may be circular in shape. In FIG. 4A, the first fastening aperture 204, the second fastening aperture 206 and the third fastening aperture 208 are shown in profile within a side view of the interface plate 202 in FIG. 4A. The fastening apertures form cylindrical holes in the interface plate 202 and have conical tips. The fastening apertures do not extend through an entirety of the depth of the interface plate 202 but rather terminate within the interface plate 202, as shown in FIG. 4A. The fourth fastening aperture 210, the fifth fastening aperture 212, and the sixth fastening aperture 214 are identical to the first fastening aperture 204, the second fastening aperture 206, and the third fastening aperture 208. The plurality of fastening apertures may be distributed around a periphery of the inlet recess 216.

The interface plate 202 may include one or more internal cooling channels. As shown in FIG. 2B, the interface plate 202 includes a first cooling channel 220 and a second cooling channel 222. (It is to be appreciated that some reference numbers have been omitted from FIG. 2B for clarity.) The cooling channels may have circular profiles and may be comprised of a plurality of straight and curved sections to allow the cooling channels to extend through the interface plate 202 and not intersect with the fastening apertures, the inlet recess 216, or charge inlet aperture 218. The first cooling channel 220 has an upward extension that extends from a first cooling inlet 224 (positioned on the bottom 211 of the interface plate 202) along a curved path before reaching a turning point near the top of the interface plate 202 and extending in the −y direction to form a downward extension that follows a parallel path to the upward extension of the first cooling channel 220. The first cooling channel 220 terminates at a first cooling outlet 226 on the bottom 211 of the interface plate 202. Coolant may flow through the first cooling channel 220 from the first cooling inlet 224 to the first cooling outlet 226 or vice versa (e.g., the first cooling outlet 226 may be an inlet that receives the coolant and the first cooling inlet 224 may be an outlet that expels the coolant). Similarly, the second cooling channel 222 has an upward extension that extends from a second cooling inlet 228 on the bottom 211 of the interface plate 202 along a curved path before reaching a turning point near the top of the interface plate 202 and extending in the −y direction to form a downward extension that follows a parallel path to the upward extension of the second cooling channel 222. The second cooling channel 222 terminates at a second cooling outlet 230 on the bottom 211 of the interface plate 202. Coolant may flow through the second cooling channel 222 from the second cooling inlet 228 to the second cooling outlet 230 or vice versa. The first cooling channel 220 is shown in profile in FIG. 4B, where the outline of the first cooling channel 220 is shown by dotted lines. FIG. 4B is not a cross sectional view of the interface plate 202 and the first cooling channel 220 is not entirely located in one z-y plane. However, as appreciated by FIG. 4B, the first cooling channel 220 is positioned intermediate the front face 203 and the main back face 234 of the interface plate 202.

The first cooling channel 220 may be coupled to an external cooling system by the first cooling inlet 224 and the first cooling outlet 226. The second cooling channel 222 may be coupled to the external cooling system by the second cooling inlet 228 and the second cooling outlet 230. The external cooling system may include a pump to circulate coolant through the cooling channels and to a heat exchanger. However, other cooling configurations are possible. In some examples, the first cooling channel 220 and the second cooling channel 222 may be replaced by heat pipes, or by a solid piece of a thermally conductive material in contact with a heat exchanger. Different cooling configurations may utilize different cooling pipe configurations, since they may demand different cooling channel diameters and orientations.

FIGS. 5A and 5B depict the back 500 of the interface plate 202. The interface plate 202 may have a main back face 234. The main back face 234 may be planar (extending in an x-y plane) and rectangular with rounded corners and may include the charge inlet aperture 218. The main back face 234 may include a channel 232 that extends along the outer perimeter of the interface plate and is spaced apart from the outer perimeter by a perimeter segment 233 of the main back face 234. The channel 232 may have a depth of 4 mm, a width of 4 mm, and may be spaced apart from the outer perimeter of the interface plate 202 by 5 mm. The channel 232 may be configured to accommodate an O-ring or another sealing mechanism in order to facilitate sealing between the interface plate and power electronics within the vehicle or another component of the vehicle. In some examples, power electronics that couple to the charge inlet may be included within a charge module (e.g., a PDU) that may be sealed to the back 500 of the interface 202 via an O-ring in the channel 232. Thus, the dimensions of the channel 232 specified above may be based on the sealing mechanism and other dimensions are possible without departing from the scope of this disclosure. It is to be appreciated that in both FIGS. 2B and 5B, aspects of the interface plate 202 that are not visible from the front (for FIG. 2B) or from the back (for FIG. 5B) are shown in dashed lines, including the cooling channels in both FIG. 2B and FIG. 5B as well as the channel 232 in FIG. 2B and the apertures and the inlet recess in FIG. 5B. In FIG. 5B, some reference numbers have been omitted for clarity.

As appreciated by the cross-sectional view shown in FIG. 6, the inlet recess 216 has a depth that extends at least to the cut plane (line A-A′ of FIG. 3). Further, the interface plate 202 is comprised of solid material other than the cooling channels, charge inlet aperture, the plurality of apertures, and inlet recess.

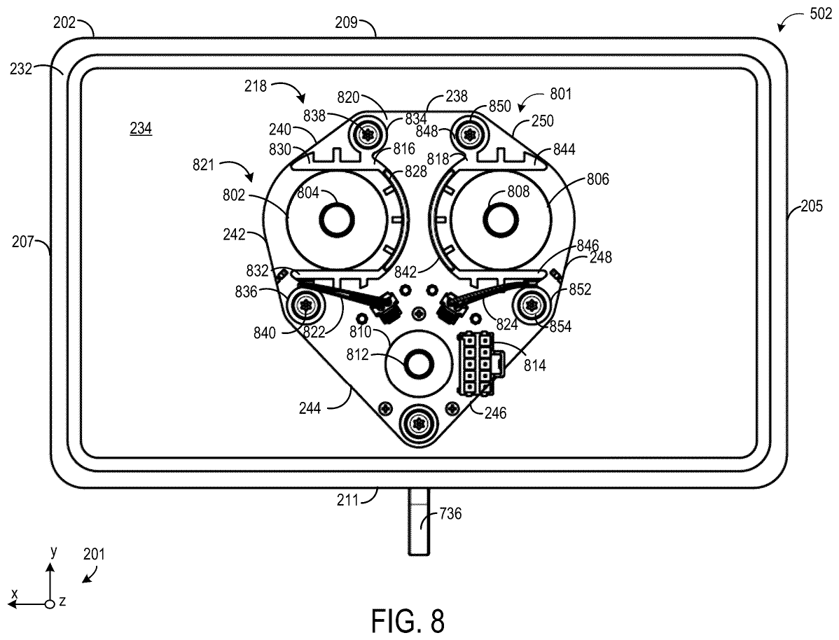

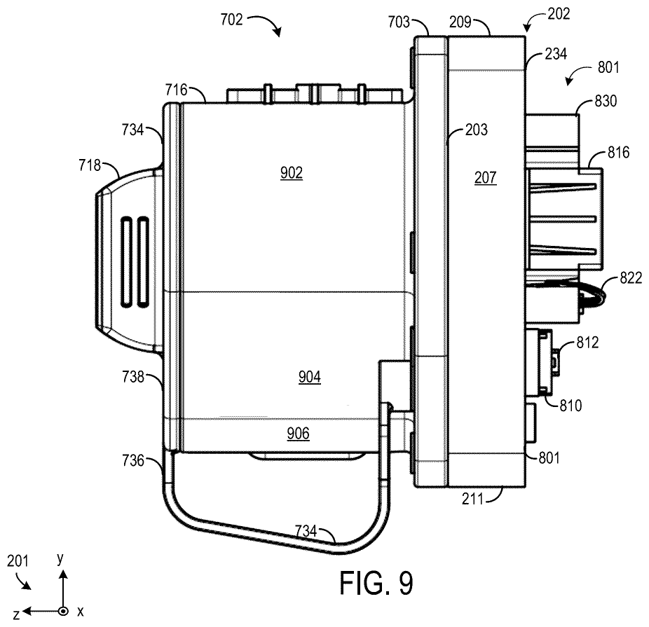

FIG. 7 depicts a view of the front face 203 of the interface plate 202 coupled to a charge inlet, which in the illustrated example is a MCS charge inlet 702. The MCS charge inlet 702 may have a front side 721 shown in FIG. 7 and a back side 821 shown in FIG. 8. A side view of the MCS charge inlet 702 is shown in FIG. 13 for reference, with FIG. 9 showing a side view of the MCS charge inlet 702 coupled to the interface plate 202. Aspects of the front of the interface plate 202 may be coupled to the back of the MCS charge inlet 702. The MCS charge inlet 702 may be installed in a vehicle in such a way that the front side 721 of the MCS charge inlet 702 is accessible from the exterior of the vehicle and configured to couple to a charge coupler (e.g., of a charging station), and the back side 821 of the MCS charge inlet 702 may be in electrical contact with power electronics within the vehicle, such as a power distribution unit or battery. The MCS charge inlet 702 includes a main body 716 and a fastening plate 703. The main body 716 may include a plurality of electrical components that couple the MCS charge inlet 702 to power electronics within the vehicle, and the electrical components may be encased by a plastic or metal external shell. The fastening plate 703 may be coupled to the main body 716 and may be a wide, thin extension of the external shell of the main body 716. The MCS charge inlet 702 may further include a protruding assembly 801 that extends from the main body 716. The protruding assembly 801 is shown in FIG. 8 and FIG. 13 and may include a plurality of electronics and coupling apparatuses to allow the charge inlet to couple to power electronics within the vehicle. The main body 716 may include a removable/translatable cover 732 that may protect electrical components within the main body 716, such as contact points between the MCS charge inlet 702 and a charge coupler. The cover 732 may have a cover front 738 that lies in the x-y plane.

A handle 718 may extend from the cover front 738. The handle 718 may allow the cover 732 to be lifted or removed to expose power electronics capable of coupling the MCS charge inlet 702 to a charge coupler. A tether 734 may couple the cover 732 to the fastening plate 703. The tether 734 may be made of a flexible plastic and prevent the cover 732 from being lost when the cover 732 is removed from the main body 716. The tether 734 may be coupled to the cover 732 by an attachment site 736 that extends out of the face of the cover 732. The attachment site 736 may be triangular in shape and the tether 734 may extend in the same plane as the cover front.

The inlet recess 216 may be formed to match the shape of the main body 716. The main body 716 is in the form of an irregular heptagon with rounded corners that is symmetric about a center line parallel to the y-axis. The inlet recess 216 has a similar shape but includes the semicircular notches to accommodate fasteners on the main body 716. The inlet recess 216 may have a depth (e.g., 22 mm) that allows the main body 716 to extend to a specific depth within the interface plate 202 and that allows the protruding assembly 801 to extend through the charge inlet aperture 218 a specific amount (e.g., 20 mm). The charge inlet aperture 218 may be formed to match the shape of the protruding assembly 801 of the MCS charge inlet. The protruding assembly 801 may have an irregular heptagon shape with rounded corners, which may be matched by the charge inlet aperture 218.

The interface plate 202 may be of the same height as the fastening plate 703 of the MCS charge inlet 702. The interface plate 202 may be wider than the fastening plate 703 and be rectangular in shape to allow cooling channels to extend within the interface plate 202 and provide additional exposed surface area for dissipating heat. A larger interface plate 202 may be able to absorb more heat than a smaller interface plate, which may allow the interface plate 202 to cool the MCS charge inlet more effectively.

The MCS charge inlet 702 may be attached to the interface plate 202 by a plurality of fasteners including a first fastener 704, a second fastener 706, a third fastener 708, a fourth fastener 710, a fifth fastener 712, and a sixth fastener 714. These fasteners may be screws, bolts, or another such fastener that extend through apertures in the fastening plate 703, such as a first aperture 720, a second aperture 722, a third aperture 724, a fourth aperture 726, a fifth aperture 728 and a sixth aperture 730, into fastening apertures in the interface plate 202. The first fastener 704 may extend through the first aperture 720 and the first fastening aperture 204, the second fastener 706 may extend through the second aperture 722 and the second fastening aperture 206, the third fastener 708 may extend through the third aperture 724 and the third fastening aperture 208, the fourth fastener 710 may extend through the fourth aperture 726 and the fourth fastening aperture 210, the fifth fastener 712 may extend through the fifth aperture 728 and the fifth fastening aperture 212, the sixth fastener 714 may extend through the sixth aperture 730 and the sixth fastening aperture 214.

FIG. 8 depicts a view of the back 502 of the interface plate 202 while the interface plate is coupled to the MCS charge inlet 702. The back side 821 of the MCS charge inlet 702 may include components configured to be coupled to power electronics within the vehicle (e.g., via busbars that are illustrated in FIGS. 10-12). The MCS charge inlet 702 includes the protruding assembly 801 that extends from the main body 716 of the MCS charge inlet 702 and through the charge inlet aperture 218. The protruding assembly 801 of the MCS charge inlet 702 may house a plurality of power electronics, at least some of which may extend out from the protruding assembly 801. The protruding assembly 801 may include a back face 820 that may support various protective shells, as explained in more detail below. The protruding assembly 801 may house/support a first pin 804 and a second pin 808 that are made of a conductive material and are capable of transferring current to power electronics within the electric vehicle. Each pin may be surrounded by a respective circular plastic shell that protects the pin from making electrical contact with other components of the MCS charge inlet 702. A first circular plastic shell 802 surrounds the first pin 804 and a second circular plastic shell 806 surrounds the second pin 808. A first plastic shell 816 surrounds the first circular plastic shell 802 and a second plastic shell 818 surrounds the second circular plastic shell 806.

The first plastic shell 816 may include a first semicircular portion 828 that surrounds the first circular plastic shell 802 and includes a plurality of ridges that extend towards the first circular plastic shell 802. The first plastic shell 816 may further include a first top section 830 and a first bottom section 832. The first top section 830 may lie parallel to the x-axis and include ridges that extend in the +y direction. The first bottom section 832 may lie parallel to the x-axis and include ridges that extend in the −y direction. The first plastic shell 816 may be affixed to the back face 820 of the MCS charge inlet 702 by a first top fastening ring 834, which may be a circular ring of plastic that a first top fastener 838 may extend through to affix to the protruding assembly 801, and a first bottom fastening ring 836, which may be a circular ring of plastic that a first bottom fastener 840 may extend through to affix to the protruding assembly 801.

The second plastic shell 818 may include a second semicircular portion 842 that surrounds the second circular plastic shell 806 and includes a plurality of ridges that extend towards the second circular plastic shell 806. The second plastic shell 818 may further include a second top section 844 and a second bottom section 846. The second top section 844 may lie parallel to the x-axis and include ridges that extend in the +y direction. The second bottom section 846 may lie parallel to the x-axis and include ridges that extend in the −y direction. The second plastic shell 818 may be affixed to the back face 820 of the MCS charge inlet 702 by a second top fastening ring 848, which may be a circular ring of plastic that a second top fastener 850 may extend through to affix to the protruding assembly 801, and a second bottom fastening ring 852, which may be a circular ring of plastic that a second bottom fastener 854 may extend through to affix to the protruding assembly 801.

The first plastic shell 816 and the second plastic shell 818 may extend out of the back face 820 of the protruding assembly 801 and may prevent electrical contact between pins of differing polarities. The MCS charge inlet 702 may further include a first group of wires 822 and a second group of wires 824 that extend out of the back face 820, which may electrically couple to a temperature sensor(s) for the contact pins.

The MCS charge inlet 702 may further include a ground pin 812 made of an electrically conductive material that connects the MCS charge inlet 702 to an electrical ground. The ground pin 812 may be surrounded by a circular plastic shell 810 to protect the ground pin 812. The MCS charge inlet 702 may further include a set of in/out pins 814 that are capable of communicating information from a control unit within the electric vehicle to a control unit within the vehicle charger (e.g., charging station). In one example, the in/out pins may be used to communicate the charge level of the vehicle battery to the charger in order to end the charge process when the battery is full and/or activate and monitor the status of a lock motor that is configured to prevent disconnect of the charge coupler when the charge coupler is connected to the charge inlet.

FIG. 9 is a side view of the MCS charge inlet 702 coupled to the interface plate 202. The fastening plate 703 is coupled in face-sharing contact with the interface plate 202 (e.g., a back face of the fastening plate 703 may be in face-sharing contact with the front face 203 of the interface plate 202). The main body 716 of the MCS charge inlet 702 is shown coupled to the fastening plate 703, and the main body 716 and the fastening plate 703 may be formed out of the same material. The main body 716 may include a first face 902 that may be curved towards the top of the main body, a second face 904 that extends diagonally in the +x direction and a third face 906 that may be curved.

As appreciated by comparing FIG. 9 to FIG. 13, the protruding assembly 801 may be accommodated within the interface plate 202. Specifically, the protruding assembly 801 may have an irregular heptagon shape that matches the shape of the inlet recess 216, with fasteners positioned around the outer edge of the protruding assembly 801. Each fastener of the protruding assembly 801 may be accommodated within a respective semicircular notch of the inlet recess 216. The protruding assembly 801 may include a plurality of side faces, such as a first side face 803 and a second side face 805, and each side face may be positioned in face-sharing contact with a respective recess segment of the inlet recess 216. For example, the first side face 803 may be positioned in face-sharing contact with the second recess segment 252 and the second side face 805 may be positioned in face-sharing contact with the third recess segment 254. In other examples, the side faces of the protruding assembly 801 may be positioned next to, but spaced apart by a small gap (e.g., 1 mm or less), the recess segments of the inlet recess 216. The recessed surface 217 may be in face-sharing contact with portions of the back face 820 of the protruding assembly 801. In some examples, the charge inlet may include an integrated sealing feature to allow installation on a panel or enclosure face. An appropriate surface and profile to mate with the seal on the charge inlet may be included on the interface plate 202 (e.g., on the front of the interface plate).

Some components of the MCS charge inlet 702 may extend through the charge inlet aperture 218 (e.g., the components visible in FIG. 8). For example, the first plastic shell 816 can be seen extending in the z axis out of the back face 820 of the protruding assembly 801; the back face 820 may be accommodated within the charge inlet aperture 218 and the first plastic shell 816 (and the first pin 804 that is accommodated within the first plastic shell 816) may extend outward through the charge inlet aperture 218.

FIGS. 10, 11, and 12 are a back view, a side view, and a perspective view, respectively, of the MCS charge inlet 702 coupled to the interface plate 202, a first busbar 1002, and a second busbar 1004. FIGS. 10, 11, and 12 are described collectively. The first busbar 1002 and the second busbar 1004 may be coupled to the interface plate 202 via insulating material. The first busbar 1002 may have an outer side profile 1104 (e.g., an outer side face) in the y-z plane. The outer side profile 1104 of the first busbar 1002 may be L-shaped, with a first rectangular protrusion 1046 extending out of a first rectangular base 1048 and extending perpendicular to the first rectangular base 1048. The first rectangular base 1048 may be defined by a first back face 1106, a first base top face 1112, and a first base front face 1022 (as well as the outer side profile/face and an inner side face that is explained in more detail below). The first rectangular protrusion 1046 may extend from the bottom of the rectangular base and may be defined by a first protruding top face 1044 that extends from the first base front face 1022, a first protruding front face 1018, and a first bottom face 1042 (as well as the outer side profile/face and an inner side face). The first bottom face 1042 may protrude past the extent of the first base top face 1112 to create the L-shaped outer side profile 1104. The first base top face 1112, the first protruding top face 1044, the first protruding front face 1018, and the first bottom face 1042 may be rectangular in shape. The first base front face 1022 of the first busbar 1002 may be planar and rectangular in shape with a first semicircular protrusion 1030 extending in the x-direction. The first semicircular protrusion 1030 may contain a first pin aperture 1014. The first pin aperture 1014 may be configured to electrically couple to the first pin 804 of the MCS charge inlet 702. The first pin 804 may be of a particular polarity (e.g. positive or negative), and by electrical coupling, the first busbar 1002 shares the particular polarity. The first rectangular protrusion 1046 may be coupled to power electronics within the electric vehicle such as a power distribution unit. The first busbar 1002 further includes a first inner side face 1050 that extends from the first base top face 1112 to the first bottom face 1042. The first inner side face 1050, when viewed from the side, may have an L-shaped profile but may extend outward in the positive x direction and then inward in the negative x direction at the first semicircular protrusion 1030.

The first busbar 1002 may be thermally coupled to the interface plate 202 but electrically insulated from the interface plate 202. A first back layer of thermal interface material (e.g., silicone) 1102 may electrically insulate the first busbar 1002 from the interface plate 202 and transfer thermal energy from the first busbar 1002 to the interface plate 202. A first bottom layer of thermal interface material 1006 is coupled to the first bottom face 1042 of the first busbar 1002. The first bottom layer of thermal interface material 1006 may electrically insulate the first bottom face 1042 of the first busbar 1002 from power electronics within the vehicle.

The second busbar 1004 is identical to the first busbar 1002 with the features of the first busbar 1002 reflected across a y-z plane shown in FIG. 10 by a dashed line 1026. Similar to the first busbar 1002, the second busbar 1004 may have an L-shaped outer side profile/face 1025. The second busbar 1004 may have a second rectangular protrusion 1034 extending out of a second rectangular base 1036 and perpendicular to the second rectangular base 1036. The second rectangular base 1036 may be defined by a second back face (not shown), a second base top face 1043, and a second base front face 1024. The second rectangular protrusion 1034 may extend from the bottom of the second rectangular base 1036 and may be defined by a second protruding top face 1038 that extends from the second base front face 1024, a second protruding front face 1020, and a second bottom face 1040. The second bottom face 1040 may protrude past the extent of the second base top face 1043 to create the L-shaped outer profile. The second base top face 1043, the second protruding top face 1038, the second protruding front face 1020, and the second bottom face 1040 may be rectangular in shape. The second base front face 1024 of the second busbar 1004 may be planar and be rectangular in shape with a second semicircular protrusion 1032 extending in the x-direction. The second semicircular protrusion 1032 may contain a second pin aperture 1016. The second pin aperture 1016 may be configured to electrically couple to the second pin 808 of the MCS charge inlet 702. The second pin 808 may be of a particular polarity (e.g. positive or negative) that may be the opposite polarity of the first pin 804, and the second busbar 1004 shares the particular polarity by electrical coupling. The second rectangular protrusion 1034 may be coupled to power electronics within the electric vehicle such as a power distribution unit. The second busbar 1004 may have a second inner side face 1202 that extends from the second base top face 1043 to the second bottom face 1040 and has the L-shaped profile similar the outer side profile of the second busbar 1004 but includes a semicircular curved portion to accommodate the second semicircular protrusion 1032 (e.g., the second inner side face 1202, when viewed from the side, may have an L-shaped profile but may extend inward in the negative x direction and then outward in the positive x direction at the second semicircular protrusion 1032).

The second busbar 1004 may be thermally coupled to the interface plate 202 but electrically insulated from the interface plate 202. A second back layer of thermal interface material (not shown) may electrically insulate the second busbar 1004 from the interface plate 202 and transfer thermal energy from the second busbar 1004 to the interface plate 202. A second bottom layer of thermal interface material 1008 is coupled to the second bottom face 1040 of the first busbar 1002. The second bottom layer of thermal interface material 1008 may electrically insulate the second bottom face 1040 of the second busbar 1004 from power electronics within the vehicle. The thermal interface material (for both busbars) may be comprised of silicone or another suitable material.

Thus, an interface plate is disclosed herein that may be mounted on the back side (e.g., an interior side, within an interior of an electric vehicle) of a charge inlet in order to cool the charge inlet. The interface plate may include a front face configured to be positioned in face-sharing contact with the charge inlet, a back face opposite the front face, a charge inlet aperture, an inlet recess surrounding the charge inlet aperture and including a recessed surface that is recessed relative to the front face, and a cooling channel integrated within the interface plate. The charge inlet aperture may be defined by an inner surface comprised of a plurality of aperture segments that extend from the recessed surface to the back face. In this way, the inlet recess may be shaped to accommodate aspects of the charge inlet (e.g., the protruding assembly described above) and secure the front face of the interface plate (and the recessed surface) in face-sharing contact with the charge inlet. The charge inlet aperture may be smaller (e.g., in diameter) than the inlet recess, such that the back face of the interface plate may have more surface area than the front face of the interface plate. The extra surface area provided on the back face may allow mounting of a pair of busbars to the back face and additional heat dissipation via the busbars, while the charge inlet aperture allows components of the charge inlet (e.g., pins and structures surrounding and protecting the pins) to extend through the center of the interface plate unobstructed so that the components may be coupled to vehicle power electronics, such as a power distribution unit. The busbars mounted on the rear face of the interface plate may provide an electrical coupling between pins of the charge inlet that extend through the charge inlet aperture and the power distribution unit, for example. The dimensions of the interface plate may be selected so as to provide a front surface that is in thermal contact with the entirety of the back of the charge inlet and allow the pins and other components of the charge inlet to extend unobstructed, while having sufficient thickness to accommodate the inner cooling channels. In doing so, cooling of the charge inlet may be provided without integrating any cooling-specific features within the charge inlet.

It is to be appreciated that the MCS charge inlet 702 is one example of a charge inlet that may be coupled to an interface plate and busbars as disclosed herein. Thus, the interface plate 202 has features configured to match features of the MCS charge inlet 702 (e.g., the particular shape of the charge inlet aperture 218). However, the interface plate disclosed herein may be configured to couple to other charge inlets without departing from the scope of this disclosure. To accommodate other models of charge inlets, the interface plate 202 may include a charge inlet aperture 218 and inlet recess 216 that are shaped according to the shape of the charge inlet used. Adjusting the shape of the charge inlet aperture 218 and the inlet recess 216 may result in the positions of the first cooling channel 220 and the second cooling channel 222 being adjusted so they effectively cool the interface plate 202.

FIGS. 2-13 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The disclosure also provides support for an interface plate for cooling a charge inlet of an electric vehicle, comprising: a front face configured to be positioned in face-sharing contact with the charge inlet, a back face opposite the front face, a charge inlet aperture, an inlet recess surrounding the charge inlet aperture and including a recessed surface that is recessed relative to the front face, wherein the charge inlet aperture is defined by an inner surface comprised of a plurality of aperture segments that extend from the recessed surface to the back face, and a cooling channel integrated within the interface plate. In a first example of the system, the system further comprises: a plurality of fastening apertures that extend from the front face and terminate within the interface plate, the plurality of fastening apertures surrounding the inlet recess. In a second example of the system, optionally including the first example, the system further comprises: a bottom face opposite a top face of the interface plate, and wherein the cooling channel includes an inlet and an outlet each positioned on the bottom face. In a third example of the system, optionally including one or both of the first and second examples, the cooling channel is a first cooling channel, the inlet is a first inlet, and the outlet is a first outlet, and further comprising a second cooling channel integrated within the interface plate, the second cooling channel having a second inlet and a second outlet each positioned on the bottom face. In a fourth example of the system, optionally including one or more or each of the first through third examples, the first cooling channel is positioned between a first side face of the interface plate and the inlet recess and the second cooling channel is positioned between a second side face of the interface plate and the inlet recess. In a fifth example of the system, optionally including one or more or each of the first through fourth examples, the inlet recess has an irregular heptagon shape configured to match a shape of a protruding assembly of the charge inlet.

The disclosure also provides support for a system for cooling a charge inlet of an electric vehicle, comprising: an interface plate comprising: a front face configured to be positioned in face-sharing contact with the charge inlet, a back face opposite the front face, a charge inlet aperture, an inlet recess surrounding the charge inlet aperture and including a recessed surface that is recessed relative to the front face, wherein the charge inlet aperture is defined by an inner surface comprised of a plurality of aperture segments that extend from the recessed surface to the back face, and a cooling channel integrated within the interface plate, and a pair of busbars configured to be positioned on the back face of the interface plate and in electrical contact with the charge inlet. In a first example of the system, the pair of busbars includes a first busbar configured to be coupled to the back face between a first side face of the interface plate and the charge inlet aperture, and a second busbar configured to be coupled to the back face between a second side face of the interface plate and the charge inlet aperture. In a second example of the system, optionally including the first example, the first busbar includes a rectangular base and a rectangular protrusion extending outward from the rectangular base and perpendicular to the rectangular base, wherein the rectangular base includes a semicircular protrusion having a first pin aperture configured to accommodate a first pin of the charge inlet, and wherein the semicircular protrusion is configured to extend partially across the charge inlet aperture. In a third example of the system, optionally including one or both of the first and second examples, the first busbar is configured to be coupled to the back face via a first layer of thermal interface material and the second busbar is configured to be coupled to the back face via a second layer of thermal interface material. In a fourth example of the system, optionally including one or more or each of the first through third examples, the cooling channel is a first cooling channel, wherein the interface plate further comprises a second cooling channel integrated within the interface plate, wherein the first cooling channel is integrated within the interface plate between the first side face and the charge inlet aperture, and wherein the second cooling channel is integrated within the interface plate between the second side face and the charge inlet aperture. In a fifth example of the system, optionally including one or more or each of the first through fourth examples, the interface plate further includes a bottom face opposite a top face of the interface plate, and wherein the first cooling channel includes a first inlet and a first outlet each positioned on the bottom face and the second cooling channel includes a second inlet and a second outlet each positioned on the bottom face.

The disclosure also provides support for a system, comprising: a charge inlet including a first pin and a second pin extending outward from a back face of a protruding assembly of the charge inlet, an interface plate coupled to the charge inlet on a front face of the interface plate, the interface plate including an inlet recess surrounding the protruding assembly and a charge inlet aperture through which the first pin and the second pin extend, and a pair of busbars coupled to the interface plate on a back face of the interface plate, the pair of busbars including a first busbar electrically coupled to the first pin and a second busbar electrically coupled to the second pin. In a first example of the system, the first busbar is coupled to the back face between a first side face of the interface plate and the charge inlet aperture, and the second busbar is coupled to the back face between a second side face of the interface plate and the charge inlet aperture. In a second example of the system, optionally including the first example, the first busbar includes a rectangular base and a rectangular protrusion extending outward from the rectangular base and perpendicular to the rectangular base, wherein the rectangular base includes a semicircular protrusion having a first pin aperture accommodating the first pin of the charge inlet, and wherein the semicircular protrusion extends partially across the charge inlet aperture. In a third example of the system, optionally including one or both of the first and second examples, the first busbar is coupled to the back face via a first layer of thermal interface material and the second busbar is coupled to the back face via a second layer of thermal interface material. In a fourth example of the system, optionally including one or more or each of the first through third examples, the interface plate further comprises a first cooling channel and a second cooling channel integrated within the interface plate, wherein the first cooling channel is integrated within the interface plate between the first side face and the charge inlet aperture, and wherein the second cooling channel is integrated within the interface plate between the second side face and the charge inlet aperture. In a fifth example of the system, optionally including one or more or each of the first through fourth examples, the interface plate further includes a bottom face opposite a top face of the interface plate, and wherein the first cooling channel includes a first inlet and a first outlet each positioned on the bottom face and the second cooling channel includes a second inlet and a second outlet each positioned on the bottom face.

When introducing elements of various embodiments of the present disclosure, the articles “a,” “an,” and “the” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object. In addition, it should be understood that references to “one embodiment” or “an embodiment” of the present disclosure are not intended to be interpreted as excluding the existence of additional embodiments that also incorporate the recited features.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. An interface plate for cooling a charge inlet of an electric vehicle, comprising:
a front face configured to be positioned in face-sharing contact with the charge inlet;
a back face opposite the front face;
a charge inlet aperture;
an inlet recess surrounding the charge inlet aperture and including a recessed surface that is recessed relative to the front face, wherein the charge inlet aperture is defined by an inner surface comprised of a plurality of aperture segments that extend from the recessed surface to the back face; and
a cooling channel integrated within the interface plate.

2. The interface plate of claim 1, further comprising a plurality of fastening apertures that extend from the front face and terminate within the interface plate, the plurality of fastening apertures surrounding the inlet recess.

3. The interface plate of claim 1, further comprising a bottom face opposite a top face of the interface plate, and wherein the cooling channel includes an inlet and an outlet each positioned on the bottom face.

4. The interface plate of claim 3, wherein the cooling channel is a first cooling channel, the inlet is a first inlet, and the outlet is a first outlet, and further comprising a second cooling channel integrated within the interface plate, the second cooling channel having a second inlet and a second outlet each positioned on the bottom face.

5. The interface plate of claim 4, wherein the first cooling channel is positioned between a first side face of the interface plate and the inlet recess and the second cooling channel is positioned between a second side face of the interface plate and the inlet recess.

6. The interface plate of claim 1, wherein the inlet recess has an irregular heptagon shape configured to match a shape of a protruding assembly of the charge inlet.

7. A system for cooling a charge inlet of an electric vehicle, comprising:
an interface plate comprising:
a front face configured to be positioned in face-sharing contact with the charge inlet;
a back face opposite the front face,
a charge inlet aperture,
an inlet recess surrounding the charge inlet aperture and including a recessed surface that is recessed relative to the front face, wherein the charge inlet aperture is defined by an inner surface comprised of a plurality of aperture segments that extend from the recessed surface to the back face, and
a cooling channel integrated within the interface plate; and
a pair of busbars configured to be positioned on the back face of the interface plate and in electrical contact with the charge inlet.

8. The system of claim 7, wherein the pair of busbars includes a first busbar configured to be coupled to the back face between a first side face of the interface plate and the charge inlet aperture, and a second busbar configured to be coupled to the back face between a second side face of the interface plate and the charge inlet aperture.

9. The system of claim 8, wherein the first busbar includes a rectangular base and a rectangular protrusion extending outward from the rectangular base and perpendicular to the rectangular base, wherein the rectangular base includes a semicircular protrusion having a first pin aperture configured to accommodate a first pin of the charge inlet, and wherein the semicircular protrusion is configured to extend partially across the charge inlet aperture.

10. The system of claim 8, wherein the first busbar is configured to be coupled to the back face via a first layer of thermal interface material and the second busbar is configured to be coupled to the back face via a second layer of thermal interface material.

11. The system of claim 8, wherein the cooling channel is a first cooling channel, wherein the interface plate further comprises a second cooling channel integrated within the interface plate, wherein the first cooling channel is integrated within the interface plate between the first side face and the charge inlet aperture, and wherein the second cooling channel is integrated within the interface plate between the second side face and the charge inlet aperture.

12. The system of claim 11, wherein the interface plate further includes a bottom face opposite a top face of the interface plate, and wherein the first cooling channel includes a first inlet and a first outlet each positioned on the bottom face and the second cooling channel includes a second inlet and a second outlet each positioned on the bottom face.

13. A system, comprising:
a charge inlet including a first pin and a second pin extending outward from a back face of a protruding assembly of the charge inlet;
an interface plate coupled to the charge inlet on a front face of the interface plate, the interface plate including an inlet recess surrounding the protruding assembly and a charge inlet aperture through which the first pin and the second pin extend; and
a pair of busbars coupled to the interface plate on a back face of the interface plate, the pair of busbars including a first busbar electrically coupled to the first pin and a second busbar electrically coupled to the second pin.

14. The system of claim 13, wherein the first busbar is coupled to the back face between a first side face of the interface plate and the charge inlet aperture, and the second busbar is coupled to the back face between a second side face of the interface plate and the charge inlet aperture.

15. The system of claim 14, wherein the first busbar includes a rectangular base and a rectangular protrusion extending outward from the rectangular base and perpendicular to the rectangular base, wherein the rectangular base includes a semicircular protrusion having a first pin aperture accommodating the first pin of the charge inlet, and wherein the semicircular protrusion extends partially across the charge inlet aperture.

16. The system of claim 14, wherein the first busbar is coupled to the back face via a first layer of thermal interface material and the second busbar is coupled to the back face via a second layer of thermal interface material.

17. The system of claim 14, wherein the interface plate further comprises a first cooling channel and a second cooling channel integrated within the interface plate, wherein the first cooling channel is integrated within the interface plate between the first side face and the charge inlet aperture, and wherein the second cooling channel is integrated within the interface plate between the second side face and the charge inlet aperture.

18. The system of claim 17, wherein the interface plate further includes a bottom face opposite a top face of the interface plate, and wherein the first cooling channel includes a first inlet and a first outlet each positioned on the bottom face and the second cooling channel includes a second inlet and a second outlet each positioned on the bottom face.
